(19) United States
(12) Patent Application Publication
(10) Pub. No.: US 2021/0254314 A1
(43) Pub. Date: Aug. 19, 2021

(54) TERMINAL DEVICE, WORK MACHINE SYSTEM, INFORMATION PROCESSING METHOD, AND SERVER DEVICE

(71) Applicant: KOMATSU LTD., Minato-ku, Tokyo (JP)

(72) Inventors: Tooru TAKATA, Minato-ku, Tokyo (JP); Kouji UEDA, Minato-ku, Tokyo (JP); Kuniyuki MORITA, Minato-ku, Tokyo (JP); Yuuichi MORI, Minato-ku, Tokyo (JP); Sachihisa ISHIKAWA, Minato-ku, Tokyo (JP); Shinichi OGAWA, Minato-ku, Tokyo (JP); Masashi HOSHINO, Minato-ku, Tokyo (JP); Junpei UEDA, Minato-ku, Tokyo (JP); Hiroki WAKABAYASHI, Minato-ku, Tokyo (JP)

(73) Assignee: KOMATSU LTD., Minato-ku, Tokyo (JP)

(21) Appl. No.: 17/049,402

(22) PCT Filed: Aug. 28, 2019
(86) PCT No.: PCT/JP2019/033702

§ 371 Date: Oct. 21, 2020

(30) Foreign Application Priority Data
Sep. 11, 2018 (JP) 2018-169368

(51) Int. Cl. E02F 9/26; G07C 5/00

(52) U.S. Cl. CPC E02F 9/268; G07C 5/008; G07C 5/006; E02F 9/264

(57) ABSTRACT

A terminal device includes a processor and a display. The processor causes the display to display a portion of a plurality of portions of a work machine which is a candidate inferred to be a cause of a failure of the work machine. The processor further causes the display to display a video or a plurality of images showing a disassembly procedure for disassembling the work machine until the portion that is the candidate is exposed.

### TECHNICAL FIELD

The present disclosure relates to a terminal device, a work machine system, an information processing method, and a server device.

### BACKGROUND ART

A conventionally known failure diagnosis device diagnoses a failure of a work machine. For example, Japanese Patent Laid-Open No. 4-315296 (PTL 1) discloses an earthmoving machine having such a failure diagnosis device. The earthmoving machine displays a failure code number of a failed location thereof on a monitor in the cab.

Japanese Patent Laid-Open No. 6-11419 (PTL 2) discloses a failure diagnosis device communicating with an earthmoving machine. The failure diagnosis device receives from a controller of the earthmoving machine an operation command issued in the earthmoving machine, a detection signal indicating a state of an operation of each member of the earthmoving machine, and a failure code signal. An IC memory card having stored therein a diagnosis procedure, failure items, a reference value, and the like described in a repair manual of the earthmoving machine is inserted into the failure diagnosis device.

Further, the failure diagnosis device of PTL 2 diagnoses a failure of the earthmoving machine based on an input received from the controller and the information stored in the IC memory card, and displays a diagnosis procedure or the like on a display unit of the failure diagnosis device. The failure diagnosis device of PTL 2 displays a diagnosis result and a remedy on the display unit. The failure diagnosis device for example displays a defective component's name and product number and a method for replacement of the component.

### CITATION LIST

### Patent Literature

PTL 1: Japanese Patent Laid-Open No. 4-315296

PTL 2: Japanese Patent Laid-Open No. 6-011419

### SUMMARY OF INVENTION

### Technical Problem

The failure diagnosis device of PTL 2 textually displays a method for replacement of a component diagnosed to be defective.

However, an inexperienced serviceman for a work machine would be unable to picture a specific operation simply by checking the replacement method in text. Therefore, even when the failure diagnosis device of PTL 2 is used, it may take time to check the state of the component and replace the component.

The present disclosure has been made in view of the above problem, and an object thereof is to provide a terminal device, a work machine system, an information processing method, and a server device that enable a serviceman to quickly confirm a state of a portion of a work machine inferred to be a cause of a failure of the work machine.

### Solution to Problem

In an aspect of the present disclosure, a terminal device includes a processor and a display. The processor causes the display to display a portion of a plurality of portions of a work machine which is a candidate inferred to be a cause of a failure of the work machine. The processor further causes the display to display a video or a plurality of images showing a disassembly procedure for disassembling the work machine until the portion that is the candidate is exposed.

### Advantageous Effects of Invention

According to the above disclosure, a serviceman can quickly confirm a state of a portion of a work machine that is inferred to be a cause of a failure of the work machine.

### BRIEF DESCRIPTION OF DRAWINGS

FIG. 1 is a diagram showing a schematic configuration of a work machine system.

FIG. 2 shows a screen displayed by a terminal device.

FIG. 3 is a diagram for illustrating a method for entering a failure code.

FIG. 4 is a diagram showing a screen displayed when an object is selected while a failure code is entered in an entry field on a home screen.

FIG. 5 is a diagram showing a screen displayed when a serial number of “3” is selected on a screen to select a swing lock switch from a plurality of candidates inferred to be a cause of a failure.

FIG. 6 is a diagram showing a rear cover and an example of displaying a video showing a disassembling procedure inside the rear cover.

FIG. 7 is a diagram showing an example of displaying a first image showing a procedure of disassembling a right console.

FIG. 8 is a diagram showing an example of displaying a second image showing the procedure of disassembling the right console.

FIG. 9 is a diagram showing an example of displaying a third image showing the procedure of disassembling the right console.

FIG. 10 is a diagram showing an example of displaying the last image showing the procedure of disassembling the right console.

FIG. 11 is a diagram showing a typical example of a hardware configuration of the terminal device.

FIG. 12 is a diagram showing a hardware configuration of a server device.

FIG. 13 is a functional block diagram for illustrating a functional configuration of each device constituting the work machine system.

FIG. 14 is a sequence diagram for illustrating a flow of processing in the work machine system.

FIG. 15 is a flowchart of a process performed in the terminal device.

### DESCRIPTION OF EMBODIMENTS

Hereinafter, an embodiment will be described with reference to the drawings. In the following description, identical components are identically denoted. Their names and functions are also identical. Accordingly, they will not be described repeatedly in detail. It is planned from the beginning to combine and use a configuration in an embodiment, as appropriate. Some components may not be used.

Hereinafter, a work machine system having a server device, a work machine and a terminal device will be described with reference to the drawings. Hereinafter, a work vehicle which is a hydraulic excavator will be described as an example of the work machine. In the following description, “rear” and “right” are terms with reference to an operator seated on an operator's seat of the work vehicle.

<A. System Configuration>

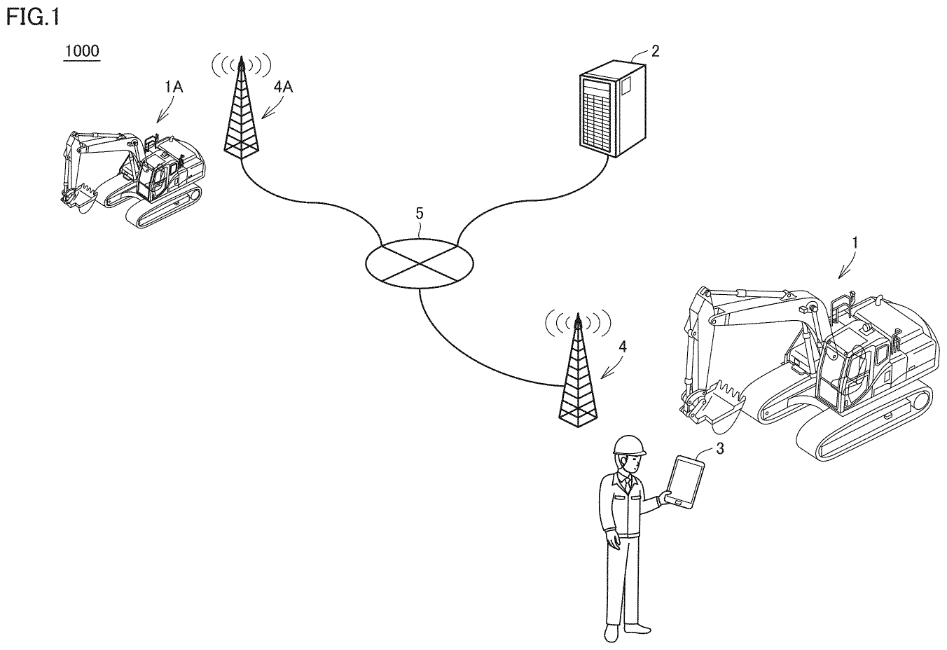

FIG. 1 is a diagram showing a schematic configuration of the work machine system based on an embodiment.

As shown in FIG. 1, a work machine system 1000 includes a plurality of work vehicles 1 and 1A, a server device 2, and a terminal device 3. The work vehicle is not limited in number to two. Terminal device 3 is not limited in number to one.

Terminal device 3 is a client device. Terminal device 3 is a portable device. Terminal device 3 is typically a tablet terminal. Terminal device 3 is used by a serviceman who provides repair and maintenance for work machines. Terminal device 3 functions as an assistive device (a failure diagnosis assisting device) assisting the serviceman to investigate a cause of a failure of work machine. For example, when work vehicle 1 fails, the serviceman carries terminal device 3 with him/her to the location of work vehicle 1 and operates terminal device 3 at the location.

Terminal device 3 is equipped with a browser. Terminal device 3 displays a Web page provided by server device 2. A variety of types of screens including (motion) videos and (still) images, which will be described hereinafter, are typically provided in the form of Web pages.

Work vehicles 1 and 1A and terminal device 3 are communicatively connected to server device 2 via a network 5. In the example of FIG. 1, work vehicle 1 and terminal device 3 are connected to network 5 via base station 4 of an area in which work vehicle 1 and terminal device 3 are located. Work vehicle 1A is connected to network 5 via a base station 4A of an area in which work vehicle 1A is located.

For communications between work vehicles 1, 1A, terminal device 3, and server device 2, the 3G communication standard, the 4G communication standard, the communication standard for Long Term Evolution (LTE) referred to as 3.9G (or Pre-4G), or the Wimax® communication standard may be used for example. Work vehicles 1, 1A and terminal device 3 may also communicate with server device 2 via a satellite line.

Terminal device 3 is an example of a “terminal device” in the present invention. Server device 2 is an example of a “server device” in the present invention. Work vehicle 1 is an example of a “work machine” in the present invention. Work vehicle 1A is an example of “another work machine” in the present invention.

<B. User Interface>

A user interface displayed at terminal device 3 will be described.

(b1. Exemplary Operation Before Displaying Disassembly Procedure)

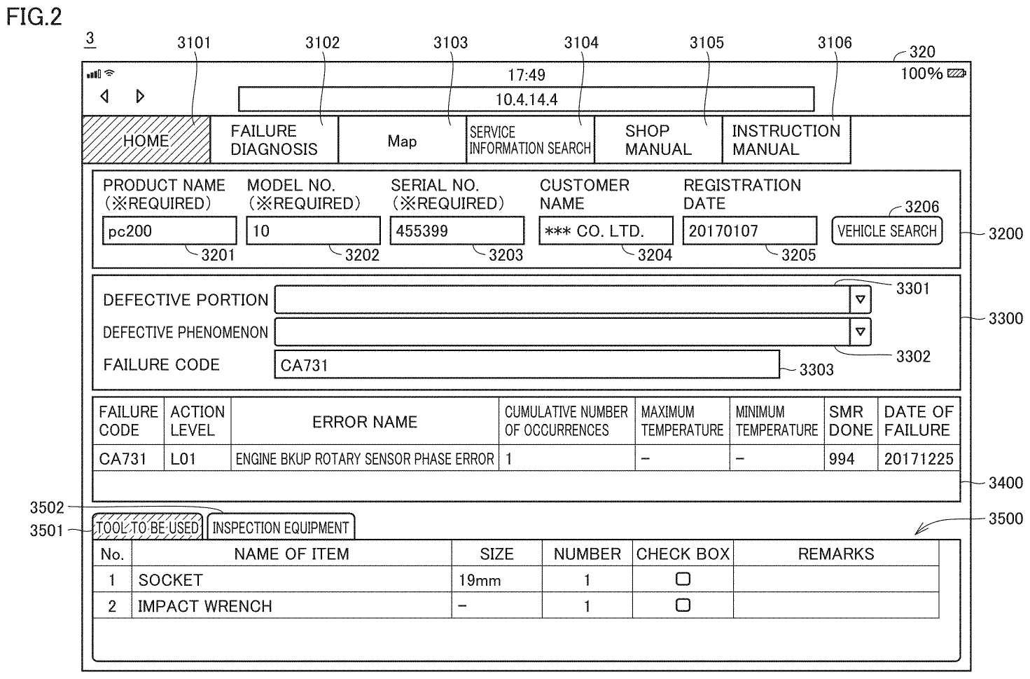

FIG. 2 shows a screen displayed on terminal device 3.

As shown in FIG. 2, a screen 320 represents a state in which a serviceman performs an input operation in an entry frame or the like displayed on a home screen. The home screen is displayed on terminal device 3 when an application program installed in terminal device 3 is executed.

(1) Description of Screen

Screen 320 has a plurality of objects 3101 to 3106, and a plurality of areas 3200, 3300, 3400, 3500.

Object 3101 is an icon for displaying the home screen. Object 3102 is an icon selected when a serviceman conducts a failure diagnosis. Object 3103 is an icon for displaying the current position of the work machine on a map. Object 3104 is an icon for displaying a maintenance history of the work machine. Object 3105 is an icon for displaying a shop manual. Object 3106 is an icon for displaying an instruction manual.

Area 3200 includes a product name entry field 3201, a model number entry field 3202, a serial number entry field 3203, a customer name entry field 3204, a registration date entry field 3205, and object 3206 for a target work machine (work vehicle 1 in the case of FIG. 1).

Area 3300 includes a defective portion entry field 3301, a defective phenomenon entry field 3302, and a failure code entry field 3303. A serviceman can enter inputs to defective portion entry field 3301 and defective phenomenon entry field 3302 using a pull-down menu.

Area 3400 is an area for displaying a failure (or an error) that the target work machine (work vehicle 1 in the case of FIG. 1) had in the past. In area 3400, automatically displayed are a failure code, an action level, an error name, how many times an error has occurred in total, a maximum temperature, a minimum temperature, an SMR (service meter reading: cumulative operating time) in the event of an error, and a date of an error. A failure code (“CA731” in the example of FIG. 2) indicated in area 3400 is configured to be selectable by an operation performed by a serviceman.

Area 3500 automatically displays information of a tool to be used and information of inspection equipment.

(2) Transition of State on Home Screen

When the serviceman enters inputs to entry fields 3201, 3202 and 3203 and subsequently selects object 3206, terminal device 3 automatically enters inputs to entry fields 3204 and 3205, as shown in the figure. When object 3206 is selected, terminal device 3 displays in area 3400 an indication, such as shown in the figure, for a failure (or error).

More specifically, when terminal device 3 receives inputs for entry fields 3201, 3202 and 3203, terminal device 3 sends the input data to server device 2. Based on the data received from terminal device 3, server device 2 extracts a customer name, a registration date, and information for a failure. Server device 2 notifies terminal device 3 of the extracted customer name, registration date, and information for the failure.

Thus, input to (or indication in) entry fields 3201 to 3205 and indication in area 3400 are implemented.

Subsequently, when the serviceman selects the failure code (“CA731” in the example of FIG. 2) indicated in area 3400, the selected failure code is automatically input in area 3300 to entry field 3303. When the failure code indicated in area 3400 is selected, terminal device 3 displays in area 3500 information of a tool to be used and information of inspection equipment that are related to the failure code. Typically, terminal device 3 obtains from server device 2 information of a tool to be used and information of inspection equipment, based on the failure code.

The inspection equipment refers to equipment used to inspect a portion (or component) while it is inspectable with a tool. The inspection equipment is, for example, equipment connected between wire harnesses for providing a branching path from the wire harnesses.

Indication in area 3300 at entry field 3303 and in area 3500, as shown in the figure, can thus be implemented.

As shown in the example of FIG. 2, terminal device 3 communicates with server device 2 to obtain information about a failure that a target work machine had in the past, and displays the obtained information in area 3400. Further, when the serviceman selects a failure code displayed in area 3400, the failure code is input to entry field 3303. However, how a failure code is input is not limited to this manner. For example, the following two methods may be used.

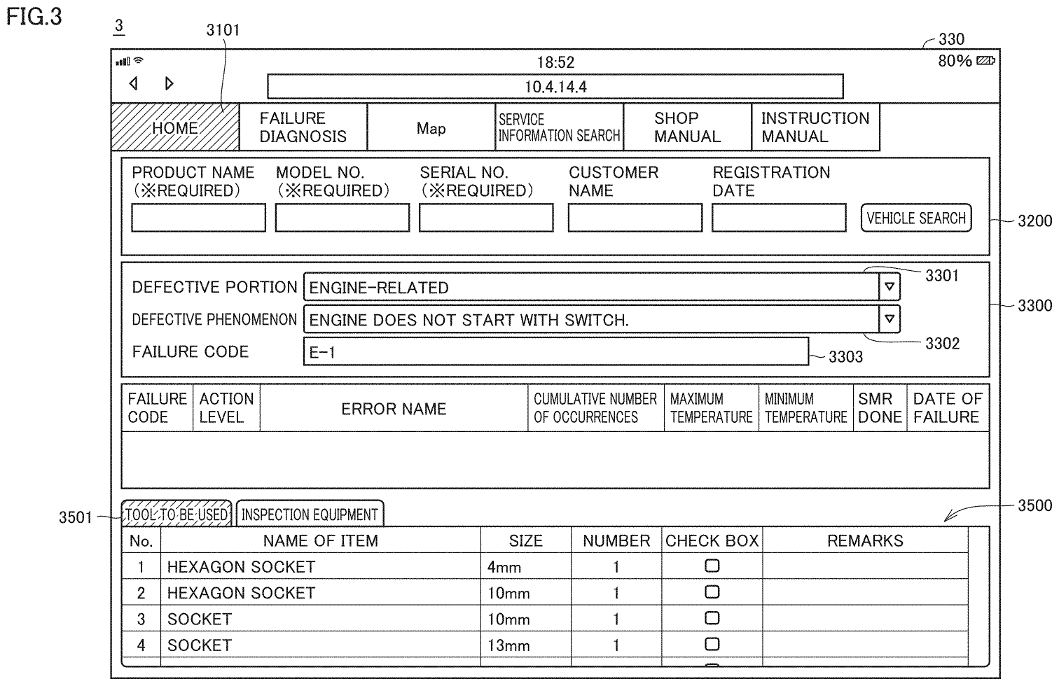

A first method is as follows: when a serviceman can determine a failure code based on a hearing from an operator or the like of work vehicle 1, the serviceman may enter the failure code to entry field 3303 in area 3300 without entering inputs to entry fields 3201 to 3203 in area 3200. Alternatively, when a serviceman operates work vehicle 1 and a failure is reproduced or the like, and the serviceman can determine a failure code, the serviceman may enter the failure code to entry field 3303 in area 3300 without entering inputs to entry fields 3201 to 3203 in area 3200. A second method will now be described with reference to FIG. 3.

FIG. 3 is a diagram for illustrating a method for entering a failure code. As shown in FIG. 3, a screen 330 represents a state when a serviceman performs an input operation for an entry frame or the like displayed on the home screen. The serviceman enters inputs to entry fields 3301 and 3302 in area 3300 based for example on a result of a hearing from an operator or the like of work vehicle 1.

When inputs are entered to entry fields 3301 and 3302, terminal device 3 displays in entry field 3303 a failure code determined based on these inputs. The failure code may be determined in server device 2 or terminal device 3.

(3) Transition of Screen from Home Screen

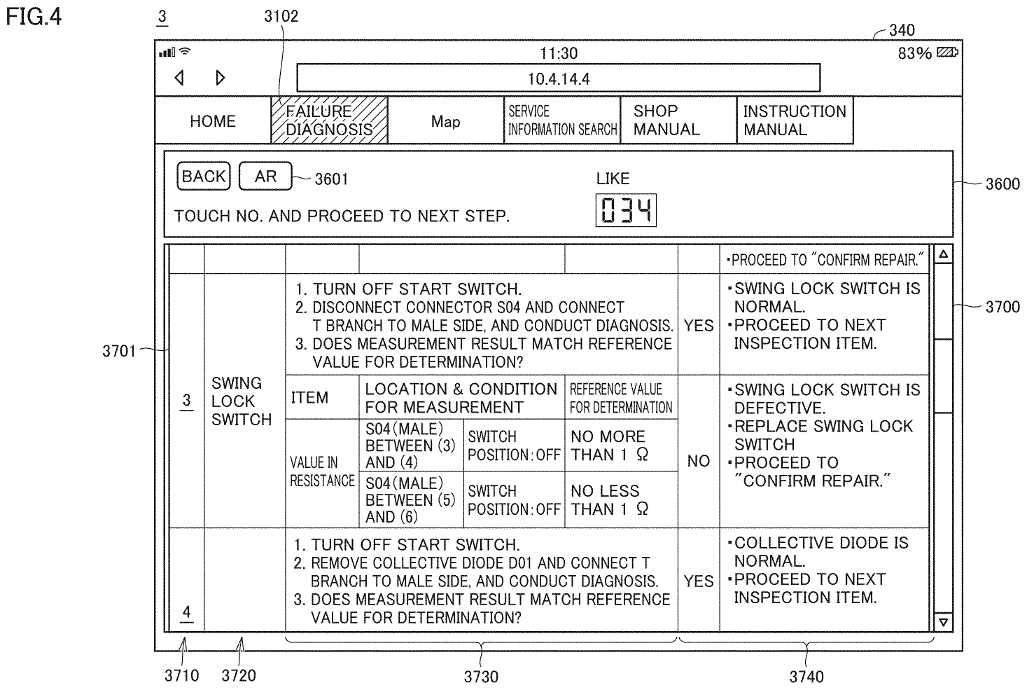

FIG. 4 is a diagram showing a screen displayed when object 3102 is selected while a failure code is entered in entry field 3303 on the home screen.

As shown in FIG. 4, a screen 340 has an area 3600 and an area 3700. Area 3600 includes a selectable object 3601. When object 3601 is selected by a serviceman, terminal device 3 shifts to an augmented reality display mode. In this mode, when the serviceman has terminal device 3 with a back surface thereof (i.e., a surface thereof opposite to a display thereof and provided with a camera) directed toward work vehicle 1, an internal structure of work vehicle 1 is displayed in a manner in which it is superimposed on work vehicle 1.

Terminal device 3 displays in area 3700 a failure handling manual 3701 based on the failure code entered in entry field 3303. Failure handling manual 3701 may be obtained from server device 2 as terminal device 3 sends a failure code to server device 2, or may be stored previously in terminal device 3.

Failure handling manual 3701 includes caption fields 3710, 3720, 3730, 3740. Failure handling manual 3701 is configured to be scrollable at least vertically.

Caption field 3710 indicates serial numbers in failure handling manual 3701. Each serial number can be selected by a serviceman. Caption field 3720 indicates some of a plurality of portions (e.g., components) of the work machine which are a plurality of candidates inferred to be a cause of a failure of the work machine for each serial number. Terminal device 3 allows a serviceman to select a serial number to select a single portion from the plurality of candidates.

Caption field 3730 indicates for each serial number a failure diagnosis procedure, a location for measurement, a reference (value), and remarks for the candidate (or portion). Caption field 3740 indicates a diagnosis result and a remedy for each serial number.

Terminal device 3 thus displays on the display of terminal device 3 some of the plurality of portions of work vehicle 1 which are a plurality of candidates inferred to be a cause of a failure of work vehicle 1. Terminal device 3 receives an input which selects one portion from the plurality of candidates.

When terminal device 3 receives an input which selects one portion from the plurality of candidates, terminal device 3 shifts the display screen from screen 340 to a screen corresponding to the selected portion.

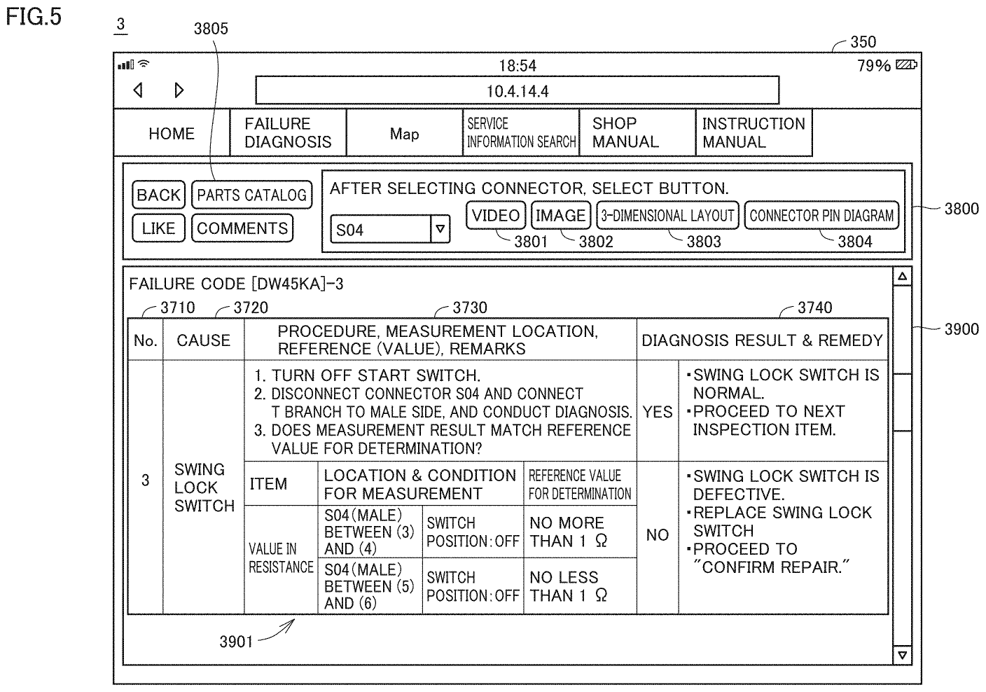

FIG. 5 is a diagram showing a screen displayed when a serial number of “3” is selected on screen 340 to select a swing lock switch from a plurality of candidates inferred to be a cause of a failure.

As shown in FIG. 5, a screen 350 includes an area 3800 and an area 3900. Terminal device 3 displays a plurality of objects 3801 to 3805 in area 3800. Terminal device 3 displays a failure handling manual 3901 for the “swing lock switch,” which is an example of the selected portion, in area 3900. Failure handling manual 3901 is a partial extraction of failure handling manual 3701. Accordingly, failure handling manual 3901 includes a failure diagnostic procedure, a location for measurement, a reference (value), and remarks for the swing lock switch. Further, failure handling manual 3901 includes a diagnosis result and information of a remedy.

When the serviceman selects object 3801, terminal device 3 displays on the display of terminal device 3 a video showing a “disassembly procedure for disassembling work vehicle 1 until the selected portion, or the swing lock switch, is exposed.”

Typically, when object 3801 is selected, terminal device 3 obtains (or downloads) from server device 2 video data representing a disassembly procedure. When the serviceman enters an input to terminal device 3 to play the obtained video data, terminal device 3 plays the video data. Thus, the video showing the disassembly procedure is displayed on the display.

When the serviceman selects object 3802, terminal device 3 displays on the display of terminal device 3 a plurality of (still) images showing the “disassembly procedure for disassembling work vehicle 1 until the selected portion, or the swing lock switch, is exposed.” Typically, terminal device 3 displays images one by one.

Object 3801 is an example of a “first object” in the present invention. Object 3802 is an example of a “second object” in the present invention.

(b2. Displaying Disassembly Procedure by Video)

Hereinafter will be described by way of example a disassembly procedure taken when a specific component inside a rear cover is a selected portion.

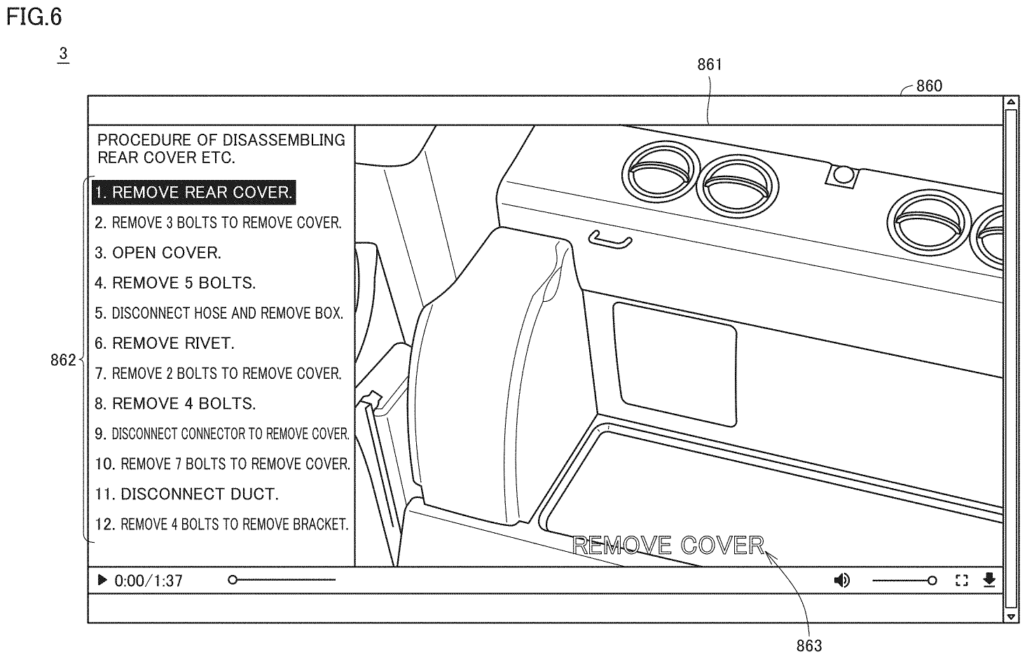

FIG. 6 is a diagram showing the rear cover and an example of displaying a video showing a disassembling procedure inside the rear cover.

As shown in FIG. 6, terminal device 3 displays on the display a screen 860 including a video 861 representing a disassembly procedure. By confirming the video, the serviceman can easily understand the disassembly procedure. The serviceman can thus quickly confirm the state of a portion inferred to be a cause of a failure of work vehicle 1. In addition, the serviceman can quickly perform a work to repair or replace the portion inferred to be the cause of the failure of work vehicle 1.

Screen 860 further includes textual information 862 indicating the disassembly procedure in time series. Typically, textual information 862 is composed of text indicating each step of the disassembly procedure, and each text is numbered and arranged in an order in which the work machine is disassembled. Such an indication allows the serviceman to easily understand a flow of the entire disassembly operation.

When terminal device 3 starts playing a video in response to an operation performed by the serviceman, text corresponding to a displayed scene is displayed in a manner different than other text. In the aspect of the figure, a scene in which the cover is removed is played, and accordingly, terminal device 3 emphasizes and thus displays text such as “1. Remove cover.” Such an indication allows the serviceman to easily understand how many more of the steps (of a working process) will subsequently be required.

Further, terminal device 3 superimposes text 863 that corresponds to the displayed scene on the video and thus displays the text. In the aspect of the figure, a scene in which the cover is removed is played, and accordingly, terminal device 3 superimposes text such as “1. Remove cover.” on the video and thus displays the text. When such a configuration is compared with a video without text superimposed thereon, the former allows the serviceman to more clearly understand what step a scene of the video indicates.

Terminal device 3 is operable to stop and resume playing and rewind a video, as timed as desired. This allows the serviceman to sufficiently confirm a portion that he/she desires to confirm.

(b3. Displaying Disassembly Procedure in Image)

Hereinafter will be described by way of example a disassembly procedure taken when a specific component in a right console is a selected portion.

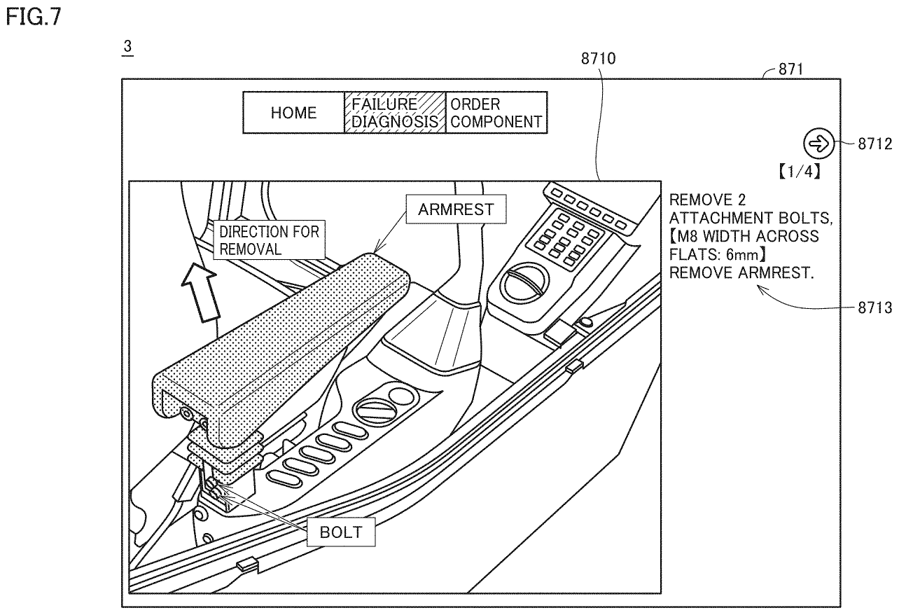

FIG. 7 is a diagram showing an example of displaying a first image (a still image) showing a procedure of disassembling the right console.

As shown in FIG. 7, terminal device 3 displays on the display a screen 871 including an image 8710 of the right console. Screen 871 further includes an object 8712, and a caption 8713 for a disassembling method.

Image 8710 displays a component to be removed (an armrest in this example) in a noticeable manner. For example, the armrest is displayed in a color (for example, red) different from its original color. This allows the serviceman to immediately recognize a component to be removed in this aspect.

Image 8710 also includes an image indicating the location of a component involved in removing the armrest. In this example, image 8710 indicates a bolt which secures the armrest by a leader line and text. Such an indication allows the serviceman to easily understand the location of the component for removing the armrest. As well as the armrest, terminal device 3 preferably displays the bolt in a color different from its original color.

Further, image 8710 includes an image of an arrow indicating a direction in which the armrest is removed. This indication allows the serviceman to easily understand the direction in which the armrest is removed (a direction of movement).

The serviceman can confirm caption 8713 together with image 8710 to more accurately understand work contents. Typically, caption 8713 includes a component name (in this example, “armrest” and “bolt”) displayed in image 8710 in text. Caption 8713 may also include information (in this example, “M8, width across flats: 6 mm”) that is not shown in image 8710.

After the serviceman removed the armrest, the serviceman can select object 8712 to shift the display screen of terminal device 3 from screen 871 to a next screen.

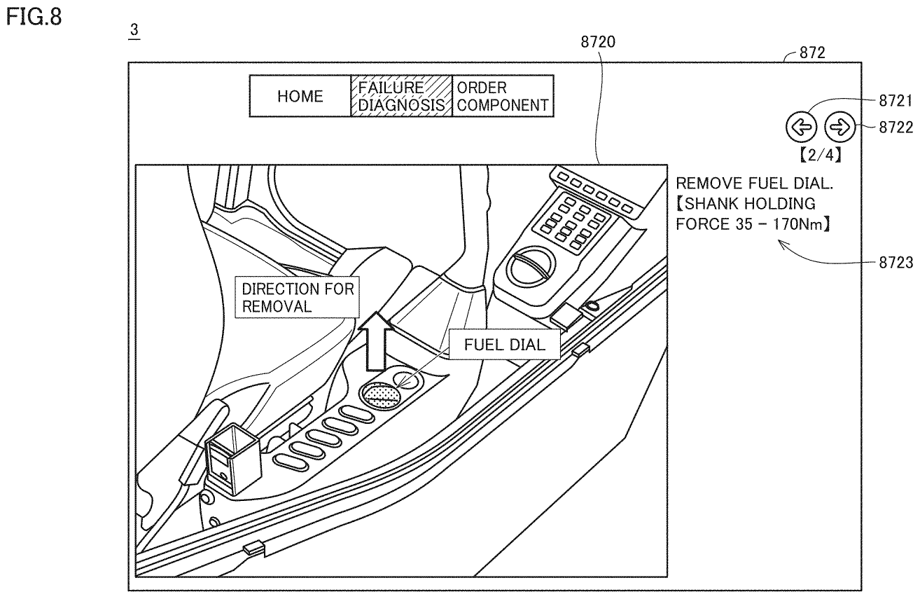

FIG. 8 is a diagram showing an example of displaying a second image (a still image) showing the procedure of disassembling the right console.

As shown in FIG. 8, terminal device 3 displays on the display a screen 872 including an image 8720 of the right console after the armrest is removed. Screen 872 further includes objects 8721 and 8722, and a caption 8723 for the disassembling method.

Image 8720 displays a component to be removed (in this example, a fuel dial) in a noticeable manner. This allows the serviceman to immediately recognize a component to be removed in this aspect.

Image 8720 also includes an image of an arrow indicating a direction in which the fuel dial is removed. This indication allows the serviceman to easily understand the direction in which the fuel dial is removed.

The serviceman can confirm caption 8723 together with image 8720 to more accurately understand work contents.

After the serviceman removed the fuel dial, the serviceman can select object 8722 to shift the display screen of terminal device 3 from screen 872 to a next screen. The serviceman can select object 8721 to shift the display screen of terminal device 3 from screen 872 back to the immediately previous screen or screen 871.

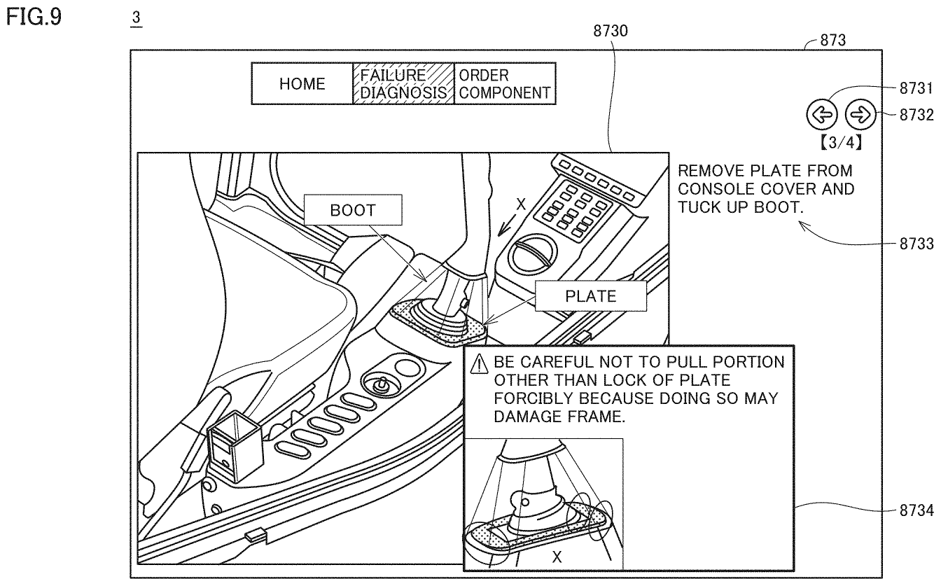

FIG. 9 is a diagram showing an example of displaying a third image (a still image) showing the procedure of disassembling the right console.

As shown in FIG. 9, terminal device 3 displays on the display a screen 873 including an image 8730 of the right console after the fuel dial is removed. Screen 873 further includes objects 8731 and 8732, a caption 8733 for the disassembling method, and an image 8734 indicating a matter to be attended to.

In image 8730, a component to be removed (in this example, a plate for securing a boot) is displayed in a noticeable manner. Thus, the serviceman can immediately recognize the component to be removed in this aspect.

The serviceman can confirm caption 8733 together with image 8730 to more accurately understand work contents. Further, the serviceman can confirm image 8734 indicating a matter to be attended to to perform an appropriate operation. Note that image 8734 typically includes an enlarged image of a main portion and text representing what to be attended to.

The serviceman tucks up the boot in the cab of work vehicle 1, and subsequently selects object 8732 to shift the display screen of terminal device 3 from screen 873 to a next screen. The serviceman can select object 8231 to shift the display screen of terminal device 3 from screen 873 back to the immediately previous screen or screen 872.

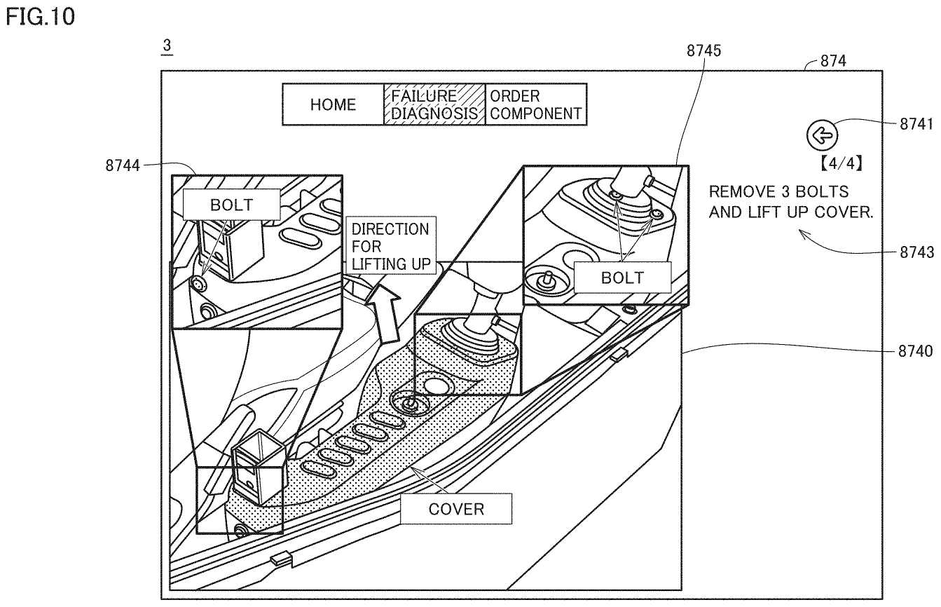

FIG. 10 is a diagram showing an example of displaying the last (or a fourth) image showing the procedure of disassembling the right console.

As shown in FIG. 10, terminal device 3 displays on the display a screen 874 including an image 8740 of the right console after the boot is tucked up. Screen 874 further includes an object 8741, and a caption 8743 for the disassembling method. Image 8740 includes images 8744 and 8745 enlarging main portions.

Image 8740 displays a component to be removed (in this example, a cover) in a noticeable manner. This allows the serviceman to immediately recognize the component to be removed in this aspect.

The serviceman can confirm caption 8743 together with image 8740 to more accurately understand work contents. Further, the serviceman can confirm images 8744 and 8745 enlarging main portions to perform an appropriate operation.

The serviceman can select object 8741 to shift the display screen of terminal device 3 from screen 874 back to the immediately previous screen or screen 873.

Terminal device 3 thus displays on the display a plurality of images showing a disassembly procedure for disassembling work vehicle 1 until a selected portion is exposed. By confirming the plurality of images, the serviceman can easily understand the disassembly procedure. The serviceman can thus quickly confirm the state of a portion inferred to be a cause of a failure of work vehicle 1. In addition, the serviceman can quickly perform a work to repair or replace the portion inferred to be the cause of the failure of work vehicle 1.

(b4. Displaying Contents Other Than Disassembly Procedure)

(1) Three-Dimensional Layout Diagram

When the serviceman selects object 3803 shown in FIG. 5, terminal device 3 displays a three-dimensional layout diagram of the selected portion, or the swing lock switch, on the display of terminal device 3. Terminal device 3 displays a three-dimensional representation of the swing lock switch together with components around the swing lock switch. Typically, when object 3803 is selected, terminal device 3 obtains image data of the three-dimensional layout diagram from server device 2, and displays on the display of terminal device 3 a three-dimensional layout image based on the image data.

Displaying the three-dimensional layout diagram of the swing lock switch allows the serviceman to easily understand the location of the swing lock switch three-dimensionally.

When the serviceman designates a partial area of the three-dimensional layout diagram, terminal device 3 displays an enlarged view of the designated area (in a three-dimensional layout diagram). This allows the serviceman to confirm the three-dimensional layout diagram in more detail.

(2) Figure of Connector Pin

When the serviceman selects object 3804, terminal device 3 displays on the display of terminal device 3 a figure of a selected portion, that is, a connector pin of the swing lock switch. Typically, when object 3804 is selected, terminal device 3 obtains image data of the connector pin from server device 2 and displays on the display of terminal device 3 a figure of the connector pin based on the image data.

Showing the figure of the connector pin allows the serviceman to confirm information of the pin and thus quickly proceed with a failure diagnosis.

(3) Parts Catalog

When the serviceman selects object 3805, terminal device 3 displays on the display of terminal device 3 a parts catalog of the selected portion, or the swing lock switch. The parts catalog includes a view of the swing lock switch disassembled into parts (bolts, nuts, springs, . . . ), detailed information of each part (a product number, etc.), and the like. Typically, when object 3805 is selected, terminal device 3 obtains image data of the parts catalog from server device 2 and displays on the display of terminal device 3 a view of the parts catalog based on the image data.

Displaying the parts catalog allows the serviceman to confirm the product number or the like of each part constituting the component that he/she has selected. The serviceman can thus quickly set up a repair.

<Hardware Configuration>

(c1. Terminal device)

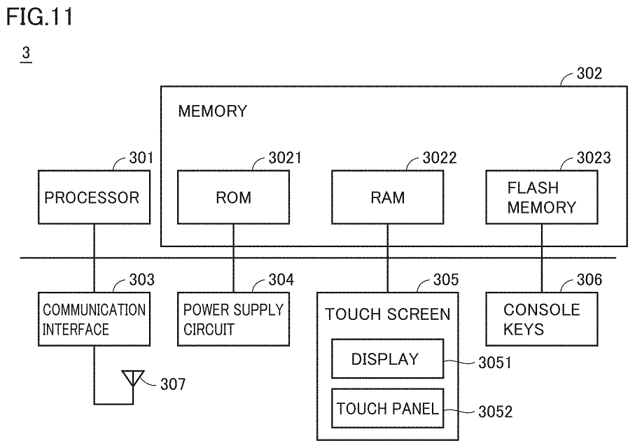

FIG. 11 is a diagram showing a typical example of a hardware configuration of terminal device 3.

As shown in FIG. 11, terminal device 3 includes a processor 301 that executes a program, a memory 302, a communication interface 303, a power supply circuit 304, a touch screen 305, console keys 306, and an antenna 307 as main components.

Memory 302 includes a ROM 3021 that stores data in a nonvolatile manner, a RAM 3022 that stores data generated by execution of the program by processor 301 or input data in a volatile manner, and a flash memory 3023 that stores data in a nonvolatile manner. Components 301 to 306 are mutually connected by a data bus.

Touch screen 305 is composed of a display 3051 and a touch panel 3052. Antenna 307 is an antenna for communication interface 303. Communication interface 303 performs, for example, a process for sending data to server device 2 and a process for receiving data sent from server device 2. Touch screen 305 is a device for displaying a variety of types of data and receiving an operation input.

Processing in terminal device 3 is implemented by each hardware and processor 301 executing software. Such software may be stored previously in flash memory 3023. The software may be stored in another storage medium and distributed as a program product. Alternatively, the software may be provided as a downloadable program product by an information provider connected to the so-called Internet. Such software is read by a reader device from the storage medium or downloaded via communication interface 303, and subsequently, temporarily stored in flash memory 3023. The software is read from flash memory 3023 by processor 301, and is further stored in RAM 3021 in the form of an executable program. Processor 301 executes the program.

Each component of terminal device 3 shown in the figure is a general component. Therefore, it can also be said that the present invention's essential part is software stored in memory 302 and/or a storage medium or software downloadable via a network. Each hardware of terminal device 3 operates in a well-known manner and accordingly, will not be described repeatedly.

Processor 301 is an example of a “processor of the terminal device” in the present invention. Display 3051 is an example of a “display” in the present invention. Touch panel 3052 is an example of an “input device” in the present invention. Communication interface 303 is an example of a “communication interface of the terminal device” in the present invention.

(c2. Server Device)

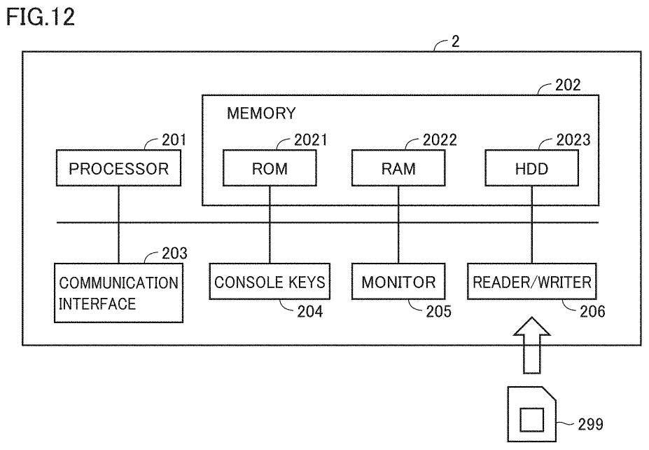

FIG. 12 represents a hardware configuration of server device 2.

As shown in FIG. 12, server device 2 includes a processor 201, a memory 202, a communication interface 203, console keys 204, a monitor 205, and a reader/writer 206. Memory 202 typically includes a ROM 2021, a RAM 2022, and an HDD (Hard Disc) 2023. Reader/writer 206 reads a variety of types of data including a program from a memory card 299 as a storage medium and writes data in memory card 299.

Processor 201 executes a program stored in memory 202. RAM 2022 temporarily stores a variety of programs, data generated by processor 201 executing a program, and data input by a user. ROM 2021 is a non-volatile storage medium, and typically stores a BIOS (Basic Input Output System) and firmware. HDD 2023 stores an OS (operating system), a variety of application programs, and the like.

Software such as a program or the like stored in memory 202 may be stored in a memory card or another storage medium and distributed as a program product. Alternatively, the software may be provided as a downloadable program product by an information provider connected to the so-called Internet. Such software is read by a memory card reader/writer or another reader device from the storage medium or downloaded via an interface, and subsequently, temporarily stored in RAM 2022. The software is read from RAM 2022 by processor 201, and is further stored in HDD 2023 in the form of an executable program. Processor 201 executes the program.

Each component constituting server device 2 shown in the figure is a general component. Therefore, it can also be said that the present invention's essential part is software stored in memory 202, a memory card and/or another storage medium, or software downloadable via a network.

The storage medium is not limited to a DVD (Digital Versatile Disc)-ROM, a CD (Compact Disc)-ROM, an FD (Flexible Disk) or a hard disk. For example, it may be magnetic tape, cassette tape, an optical disc (MO (Magnetic Optical Disc)/MD (Mini Disc)), an optical card, a mask ROM, EPROM (Electronically Programmable Read-Only Memory), EEPROM (Electronically Erasable Programmable Read-Only

Memory), a flash ROM or a similar semiconductor memory which is a medium carrying a program in a fixed manner. Furthermore, the storage medium is a non-transitory medium allowing a computer to read a program and the like therefrom, and does not include a transitory medium such as a carrier wave.

Furthermore, a program as referred to herein includes not only a program directly executable by processor 201 but also a program in the form of a source program, a compressed program, an encrypted program, and the like.

Processor 201 is an example of a “processor of the server device” in the present invention. Memory 202 is an example of a “memory of the server device” in the present invention. Communication interface 203 is an example of a “communication interface of the server device” in the present invention.

<D. Functional Configuration>

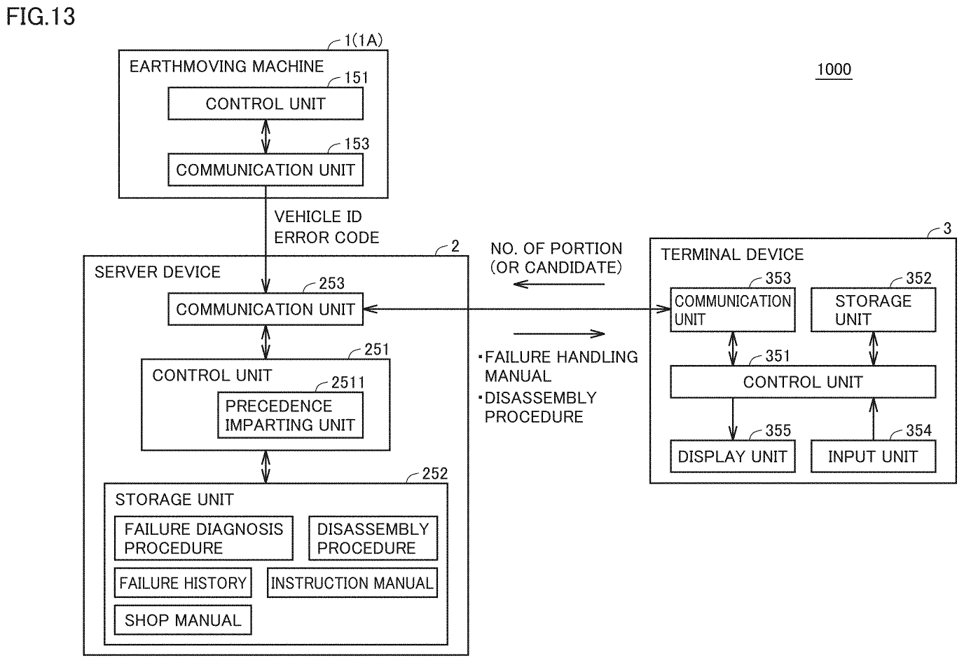

FIG. 13 is a functional block diagram for illustrating a functional configuration of each device constituting work machine system 1000.

As shown in FIG. 13, work machine system 1000 includes work vehicle 1, server device 2, and terminal device 3.

(d1. Work vehicle 1)

Work vehicle 1 includes a control unit 151 and a communication unit 153.

Control unit 151 generally control operation of work vehicle 1. Control unit 151 corresponds to a controller (not shown) of work vehicle 1. Communication unit 153 communicates with server device 2 via a base station or the like.

When work vehicle 1 fails, control unit 151 uses communication unit 153 to send to server device 2 a failure code associated with the failure.

Work vehicle 1A (see FIG. 1) has the same configuration as work vehicle 1.

(d2. Server Device 2)

Server device 2 includes a control unit 251, a storage unit 252, and a communication unit 253.

Control unit 251 includes a precedence imparting unit 2511. Processing in precedence imparting unit 2511 will be described hereinafter.

Storage unit 252 has a failure procedure, a disassembly procedure, a failure history, an instruction manual, and a shop manual stored therein in the form of digital data for each product name and each model number. Storage unit 252 has a program such as an operating system stored therein for operating server device 2.

Control unit 251 generally controls operation of server device 2. Control unit 251 communicates with work vehicle 1 (1A) via communication unit 253. Control unit 251 obtains a failure code from work vehicle 1 via communication unit 253. Control unit 251 further communicates with terminal device 3 via communication unit 253. Data sent to and received from terminal device 3 will be described hereinafter.

Control unit 251 corresponds to processor 201 in FIG. 12. More specifically, processor 201 executes a program stored in memory 202 to implement control unit 251. Communication unit 253 corresponds to communication interface 203 in FIG. 12. Storage unit 252 corresponds to memory 202 in FIG. 12.

(d3. Terminal Device 3)

Terminal device 3 includes a control unit 351, a storage unit 352, a communication unit 353, an input unit 354, and a display unit 355.

Control unit 351 generally controls operation of terminal device 3. Control unit 351 communicates with server device 2 via communication unit 353. Control unit 351 receives data input by a serviceman via input unit 354. Control unit 351 causes display unit 355 to display a variety of types of images.

Control unit 351 corresponds to processor 301 in FIG. 11. More specifically, processor 301 executes a program stored in memory 302 to implement control unit 351. Communication unit 353 corresponds to communication interface 303 in FIG. 11. Storage unit 352 corresponds to memory 302 in FIG. 11. Input unit 354 corresponds to touch panel 3052 and console keys 306 in FIG. 11. Display unit 355 corresponds to display 3051 in FIG. 11.

(d4. Data Communication and Display)

Data sent and received between terminal device 3 and server device 2 will now be described.

In terminal device 3 when a failure code is entered in entry field 3303 (see FIG. 2) and object 3102 is selected by a serviceman, terminal device 3 sends the failure code to server device 2.

When server device 2 receives the failure code from terminal device 3, server device 2 sends to terminal device 3 a failure handling manual based on the failure code. As has been set forth above, the failure handling manual includes a failure diagnosis procedure. Terminal device 3 receives the failure handling manual, and displays the failure handling manual on display unit 355, as shown in the example of screen 340 shown in FIG. 4.

When the serviceman selects one serial number (a serial number in caption field 3710 in the example of FIG. 4) in the failure handling manual, sever device 2 is notified of the selected number. When server device 2 receives the notification of the number from terminal device 3, server device 2 sends to terminal device 3 a failure handling manual relating to a component corresponding to the number (or the selected portion). As has been set forth above, the failure handling manual includes a failure diagnosis procedure.

As shown in the example of screen 350 shown in FIG. 5, terminal device 3 displays a screen including a failure handling manual for the selected portion (failure handling manual 3901 in the example of FIG. 5), object 3801 for displaying a video showing a disassembly procedure, object 3802 for displaying a image showing a disassembly procedure, object 3803 for displaying a three-dimensional layout diagram, object 3804 for displaying a connector pin diagram, and object 3805 for displaying a parts catalog.

When the serviceman selects object 3801, terminal device 3 requests server device 2 to send a video showing a “disassembly procedure for disassembling the work machine until the selected part is exposed.” In response to the request received from terminal device 3, server device 2 sends the video showing the disassembly procedure to terminal device 3. When terminal device 3 obtains the video from the server device, terminal device 3 follows an instruction provided by the serviceman to play the video.

When the serviceman selects object 3802, terminal device 3 requests server device 2 to send a plurality of images showing the “disassembly procedure for disassembling the work machine until the selected portion is exposed.” In response to the request received from terminal device 3, server device 2 sends the plurality of images showing the disassembly procedure to terminal device 3. When terminal device 3 obtains the plurality of images from the server device, terminal device 3 displays the images.

(d5. Imparting Precedence)

Referring again to FIG. 4, terminal device 3 displays some of a plurality of portions of work vehicle 1 which are a plurality of candidates inferred to be a cause of a failure of work vehicle 1. In this example has been described a case in which terminal device 3 displays the plurality of candidates together with serial numbers in the order of the serial numbers.

However, this manner of displaying the candidates is not exclusive, and each candidate may be displayed with a rank in precedence imparted thereto by a precedence imparting unit 2511 (see FIG. 13).

In server device 2, the plurality of candidates are each associated with a rank in precedence such that a candidate more probable to be the cause of the failure is given a higher rank in precedence. Typically, server device 2 determines a rank in precedence based on failure information of another work machine (for example, work vehicle 1A) different from work vehicle 1 obtained for a predetermined period of time.

The other work machine is preferably a work machine having the same product name as work vehicle 1. The other work machine is more preferably a work machine having the same product name and model number as work vehicle 1.

When terminal device 3 displays a plurality of candidates based on having received failure handling manual 3701 from the server device, terminal device 3 further displays a rank in precedence of each of the plurality of candidates. Terminal device 3 displays a rank in precedence for example in caption field 3720. Such an indication allows the serviceman to confirm a component that is indicated on a diagnostic screen of terminal device 3 in accordance with a rank in precedence to quickly identify a failed portion.

Server device 2 may send to terminal device 3 a diagnosis screen in which the plurality of candidates are each sorted in accordance with a rank in precedence. In that case, terminal device 3 displays the plurality of candidates in order from a higher rank in precedence. Such an indication allows the serviceman to immediately know an order of higher probability of failure for the plurality of candidates. When this is compared with candidates unsorted, the former allows the serviceman to quickly identify a failed portion.

<E. Flow of Process>

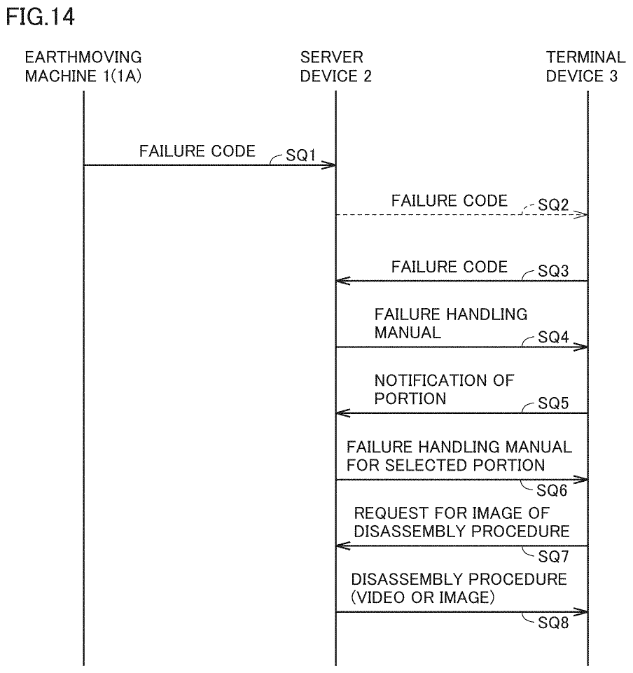

FIG. 14 is a sequence diagram for illustrating a flow of a process in work machine system 1000.

As shown in FIG. 14, when work vehicle 1 fails, then, in sequence SQ1, work vehicle 1 sends a failure code to server device 2. As shown in sequence SQ2, server device 2 may notify terminal device 3 of the failure code.

In sequence SQ3, terminal device 3 sends the failure code to server device 2. In sequence SQ4, server device 2 sends to terminal device 3 a failure handling manual corresponding to the received failure code (e.g., failure handling manual 3701 in FIG. 4).

In sequence SQ5, terminal device 3 notifies server device 2 of a portion selected by the serviceman using a number (e.g., No. 3 for “swing lock switch”). In sequence SQ6, server device 2 sends to terminal device 3 a failure handling manual for the selected portion (e.g., failure handling manual 3901 in FIG. 5).

In sequence SQ7, in response to the serviceman performing an operation to select an icon on a screen on which the failure handling manual for the selected portion is displayed (e.g., screen 350 in FIG. 5), terminal device 3 requests server device 2 to send a video or a plurality of images showing a “disassembly procedure for disassembling work vehicle 1 until the selected portion is exposed.”

In sequence SQ8, in response to the request from terminal device 3, server device 2 sends to terminal device 3 the video or the plurality of images showing the “disassembly procedure for disassembling work vehicle 1 until the selected portion is exposed.”

Thus, at terminal device 3, the serviceman can confirm the video or the plurality of images.

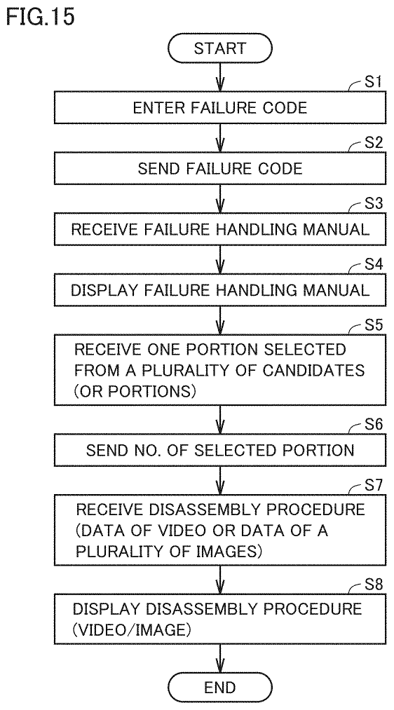

FIG. 15 is a flowchart of a process performed in terminal device 3. As shown in FIG. 15, in step S1, terminal device 3 receives an input of a failure code entered by a serviceman. Note that an input of a failure code by a serviceman is not essential.

In step S2, in response to an operation by the serviceman, terminal device 3 sends the failure code to server device 2. In step S3, terminal device 3 receives a failure handling manual including a failure diagnosis procedure from server device 2. In step S4, terminal device 3 displays the failure handling manual (see FIG. 4).

In step S5, terminal device 3 receives an operation performed by the serviceman to select one portion from a plurality of candidates (or portions). For example, in the example of FIG. 4, terminal device 3 receives an operation performed to select the number “3” or the like indicated in caption field 3710. In step S6, terminal device 3 sends the number of the selected portion to server device 2.

In step S7, terminal device 3 obtains from server device 2 an image (a video or a plurality of images) showing a “disassembly procedure for disassembling work vehicle 1 until the selected portion is exposed.” In step S8, terminal device 3 displays the obtained disassembly procedure.

<F. Summary>

(f1. Terminal Device)

Of operations of terminal device 3 described above, those in a plurality of aspects are extracted, as follows:

(1) Terminal device 3 includes processor 301 (control unit 351) and display 3051 (display unit 355).

Processor 301 causes display 3051 to display a portion of a plurality of portions of work machine 1 which is a candidate inferred to be a cause of a failure of work vehicle 1. Processor 301 further causes display 3051 to display a video or images showing a disassembly procedure for disassembling work vehicle 1 until the portion that is the candidate is exposed.

This allows a serviceman to quickly confirm the state of a portion inferred to be a cause of a failure of work vehicle 1.

(2) Terminal device 3 further includes touch panel 3052 (input unit 354) that receives an input based on a user operation.

Processor 301 causes display 3051 to display some of a plurality of portions of work vehicle 1 which are a plurality of candidates (a plurality of mutually different candidates) inferred to be a cause of a failure of work vehicle 1. In response to touch panel 3052 receiving an input to select one portion from the plurality of candidates, processor 301 causes display 3051 to display a video or a plurality of images showing a disassembly procedure for disassembling work vehicle 1 until the selected portion is exposed.

This allows the serviceman to quickly confirm the state of the portion inferred to be the cause of the failure of work vehicle 1.

(3) Terminal device 3 further includes communication interface 303 (communication unit 353) that communicates with server device 2. In response to the portion being selected, processor 301 obtains the video or the plurality of images showing the disassembly procedure from server device 2 via communication interface 303.

This eliminates the necessity of previously storing in terminal device 3 the video or the plurality of images showing the disassembly procedure.

(4) In response to the portion being selected, processor 301 causes display 3051 to display a failure handling manual for the selected portion, and an object for displaying the video or the plurality of images showing the disassembly procedure.

The serviceman confirms the failure handling manual and thereafter when the serviceman determines that it is necessary to confirm an image showing the disassembly procedure, the serviceman performs an operation to select an object, and terminal device 3 displays the video or the plurality of images showing the disassembly procedure. Terminal device 3 is thus more convenient for the user than a configuration in which after a portion is selected a video or the like would automatically be played.

(5) Processor 301 is capable of causing display 3051 to display the video showing the disassembly procedure and the plurality of images showing the disassembly procedure. In response to the portion being selected, processor 301 causes display 3051 to display as the object object 3801 for displaying the video showing the disassembly procedure (see FIG. 5) and object 3802 for displaying the plurality of images showing the disassembly procedure (see FIG. 5).

The serviceman can select object 3801 to view the video showing the disassembly procedure. Further, the serviceman can select object 3802 to view the plurality of images showing the disassembly procedure.

(6) The plurality of candidates are each associated with a rank in precedence such that a candidate more probable to be the cause of the failure is given a higher rank in precedence. When processor 301 causes display 3051 to display the plurality of candidates, processor 301 further causes display 3051 to display the rank in precedence of each of the plurality of candidates.

The serviceman can confirm a component that is indicated on a diagnostic screen of terminal device 3 in accordance with a rank in precedence to quickly identify a failed portion.

(f2. Server Device)

Of operations of terminal device 3 described above, those in a plurality of aspects are extracted, as follows:

(1) Server device 2 comprises: processor 201 (control unit 251); memory 202 (storage unit 252) having stored therein for each portion of work vehicle 1 a video or a plurality of images showing a disassembly procedure for disassembling work vehicle 1 until the portion of work vehicle 1 is exposed; and communication interface 203 (communication unit 253) for communicating with terminal device 3.

When work vehicle 1 fails, processor 201 notifies terminal device 3 via communication interface 203 of a portion of a plurality of portions which is a candidate inferred to be a cause of the failure of work vehicle 1. Processor 201 reads from memory 202 a video or a plurality of images showing a disassembly procedure for disassembling work vehicle 1 until the portion that is the candidate is exposed. Processor 201 sends to terminal device 3 via communication interface 203 the read video or plurality of images showing the disassembly procedure.

This allows a serviceman to quickly confirm the state of a portion inferred to be a cause of a failure of work vehicle 1.

(2) When work vehicle 1 fails, processor 201 notifies terminal device 3 via communication interface 203 of some of the plurality of portions which are a plurality of (mutually different) candidates inferred to be the cause of the failure of work vehicle 1. In response to receiving notification of one portion of the plurality of candidates from terminal device 3 via communication interface 203, processor 201 reads from memory 202 a video or a plurality of images showing a disassembly procedure for disassembling work vehicle 1 until the portion that processor 201 is notified of by terminal device 3 is exposed. Processor 201 sends the read video or plurality of images showing the disassembly procedure to terminal device 3 via communication interface 203.

This allows a serviceman to quickly confirm the state of a portion inferred to be a cause of a failure of work vehicle 1.

(3) Processor 201 communicates with work vehicle 1 via communication interface 203 to obtain information (or a failure code) originating from work vehicle 1. Processor 201 uses the obtained information to identify each of the plurality of candidates among the plurality of portions.

Server device 2 can thus present to terminal device 3 a plurality of candidates corresponding to a failure code.

(4) Processor 201 further obtains failure information of another work vehicle 1A different from work vehicle 1 from the other work vehicle 1A via communication interface 203. Processor 201 determines a rank in precedence based on the failure information of the other work vehicle 1A obtained for a predetermined period of time.

Server device 2 can thus notify terminal device 3 of the plurality of candidates each with a rank in precedence imparted thereto.

(f3. Work Machine System)

Of operations of work machine system 1000 described above, that in one aspect is extracted, as follows:

(1) Work machine system 1000 includes work vehicle 1, server device 2, and terminal device 3.

When work vehicle 1 fails, terminal device 3 displays a portion of a plurality of portions of work vehicle 1 which is a candidate inferred to be a cause of the failure of work vehicle 1. Terminal device 3 notifies server device 2 of the portion that is the candidate.

Server device 2 sends to terminal device 3 a video or a plurality of images showing a disassembly procedure for disassembling work vehicle 1 until the portion that server device 2 is notified of by terminal device 3 is exposed. Terminal device 3 further displays the video or the plurality of images showing the disassembly procedure received from server device 2.

This allows a serviceman to quickly confirm the state of a portion inferred to be a cause of a failure of work vehicle 1.

(2) When work vehicle 1 fails, terminal device 3 displays some of a plurality of portions of work vehicle 1 which are a plurality of candidates inferred to be a cause of the failure of work vehicle 1. Terminal device 3 receives an input selecting one portion from the plurality of candidates. Terminal device 3 notifies server device 2 of the selected portion.

Server device 2 sends to terminal device 3 a video or a plurality of images showing a disassembly procedure for disassembling work vehicle 1 until the portion selected at terminal device 3 is exposed. Terminal device 3 further displays the video or the plurality of images showing the disassembly procedure received from server device 2.

This allows a serviceman to quickly confirm the state of a portion inferred to be a cause of a failure of work vehicle 1.

<G. Modified examples>

While in the above embodiment, a configuration in which, as shown in FIG. 13, server device 2 stores a failure diagnosis procedure, a disassembly procedure, a failure history, an instruction manual, and a shop manual, and terminal device 3 obtains them as needed, has been indicated as an example and described, this is not exclusive.

Terminal device 3 may previously store a failure diagnosis procedure, a disassembly procedure, a failure history, an instruction manual, and a shop manual. Further, when a serviceman inspects work vehicle 1, necessary data may previously be read from server device 2 and stored in terminal device 3. Work vehicle 1 may be used in a place outside a communication range, and a situation in which terminal device 3 cannot obtain data such as a disassembly procedure is also expected. Even in such a situation, terminal device 3 can display an image showing the disassembly procedure.

Further, processor 301 of terminal device 3, rather than server device 2, may specify each of a plurality of candidates among a plurality of portions of work vehicle 1, based on information (or a failure code) originating from work vehicle 1.

Further, processor 301 of terminal device 3 may include precedence imparting unit 2511 and, instead of server device 2, determine a rank (in precedence) based on failure information of another work machine (for example, work vehicle 1A) different from work vehicle 1 obtained for a predetermined period of time.

The embodiments disclosed herein are merely examples, and the present invention is not limited to the above description. The scope of the present invention is indicated by the terms of the claims, and any modifications within the meaning and scope equivalent to the claims are intended to be encompassed.

### REFERENCE SIGNS LIST

1, 1A work vehicle, 2 server device, 3 terminal device, 4, 4A base station, 5 network, 151, 251, 351 control unit, 153, 253, 353 communication unit, 201, 301 processor, 202, 302 memory, 203, 303 communication interface, 204, 306 console keys, 252, 352 storage unit, 305 touch screen, 320, 330, 340, 350, 860, 871, 872, 873, 874 screen, 354 input unit, 355 display unit, 861 video, 862 textual information, 863 text, 1000 work machine system, 2511 precedence imparting unit, 3051 display, 3052 touch panel, 3101, 3102, 3103, 3104, 3105, 3106, 3206, 3601, 3801, 3802, 3803, 3804, 3805, 8712, 8721, 8722, 8731, 8732, 8741 object, 3200, 3300, 3400, 3500, 3600, 3700, 3800, 3900 area, 3201, 3202, 3203, 3204, 3205, 3301, 3302, 3303 entry field, 3701, 3901 failure handling manual, 3710, 3720, 3730, 3740 caption field, 8710, 8720, 8730, 8734, 8740 image, 8713, 8723, 8733, 8743 caption, 8744, 8745 enlarged image of main portion.

1: A terminal device comprising:
a processor; and
a display,
the processor causing the display to display a portion of a plurality of portions of a work machine which is a candidate inferred to be a cause of a failure of the work machine,
the processor further causing the display to display a video or a plurality of images showing a disassembly procedure for disassembling the work machine until the portion that is the candidate is exposed.

2: The terminal device according to claim 1, further comprising an input device that receives an input based on a user operation, wherein
the processor causes the display to display a plurality of mutually different candidates inferred to be a cause of a failure of the work machine, and
in response to the input device receiving an input to select one portion from the plurality of candidates, the processor causes the display to display a video or a plurality of images showing a disassembly procedure for disassembling the work machine until the selected portion is exposed.

3: The terminal device according to claim 2, wherein the processor determines each of the plurality of candidates from the plurality of portions based on information originating from the work machine.

4: The terminal device according to claim 2, further comprising a communication interface that communicates with a server device, wherein in response to the portion being selected, the processor obtains the video or the plurality of images showing the disassembly procedure from the server device via the communication interface.

5: The terminal device according to claim 2, wherein in response to the portion being selected, the processor causes the display to display a failure handling manual for the selected portion, and an object for displaying the video or the plurality of images showing the disassembly procedure.

6: The terminal device according to claim 5, wherein
the processor is capable of causing the display to display the video showing the disassembly procedure and the plurality of images showing the disassembly procedure, and
in response to the portion being selected, the processor causes the display to display as the object a first object for displaying the video showing the disassembly procedure and a second object for displaying the plurality of images showing the disassembly procedure.

7: The terminal device according to claim 2, wherein
the plurality of candidates are each associated with a rank in precedence such that a candidate more probable to be the cause of the failure is given a higher rank in precedence, and
when the processor causes the display to display the plurality of candidates the processor further causes the display to display the rank in precedence of each of the plurality of candidates.

8: The terminal device according to claim 7, wherein the processor determines the rank in precedence based on failure information of another work machine different from the work machine obtained for a predetermined period of time.

9: A work machine system comprising:
a work machine;
a server device; and
a terminal device, when the work machine fails, the terminal device
displaying a portion of a plurality of portions of the work machine which is a candidate inferred to be a cause of the failure of the work machine, and
notifying the server device of the portion that is the candidate,
the server device sending to the terminal device a video or a plurality of images showing a disassembly procedure for disassembling the work machine until the portion that the server device is notified of by the terminal device is exposed,
the terminal device further displaying the video or the plurality of images showing the disassembly procedure received from the server device.

10: A method performed by a terminal device for processing information, comprising:
displaying by the terminal device a portion of a plurality of portions of a work machine which is a candidate inferred to be a cause of a failure of the work machine; and
displaying by the terminal device a video or a plurality of images showing a disassembly procedure for disassembling the work machine until the portion that is the candidate is exposed.

11: A server device comprising:
a processor;
a memory having stored therein for each portion of a work machine a video or a plurality of images showing a disassembly procedure for disassembling the work machine until the portion of the work machine is exposed; and
a communication interface for communicating with a terminal device, when the work machine fails, the processor
notifying the terminal device via the communication interface of a portion of a plurality of portions which is a candidate inferred to be a cause of the failure of the work machine,
reading from the memory a video or a plurality of images showing the disassembly procedure for disassembling the work machine until the portion that is the candidate is exposed, and
sending to the terminal device via the communication interface the read video or plurality of images showing the disassembly procedure.

12: The server device according to claim 11, wherein when the work machine fails, the processor:
notifies the terminal device via the communication interface of a plurality of mutually different candidates inferred to be the cause of the failure of the work machine; and
in response to receiving notification of the portion of one of the plurality of candidates from the terminal device via the communication interface, reads from the memory a video or a plurality of images showing a disassembly procedure for disassembling the work machine until the portion that the processor is notified of by the terminal device is exposed.

13: The server device according to claim 12, wherein the processor:
communicates with the work machine via the communication interface to obtain information originating from the work machine; and
uses the obtained information to identify each of the plurality of candidates among the plurality of portions.

14: The server device according to claim 13, wherein the processor:
further obtains failure information of another work machine different from the work machine from the other work machine via the communication interface; and
determines a rank in precedence based on the failure information of the other work machine obtained for a predetermined period of time.
